(19) United States
(12) Patent Application Publication
(10) Pub. No.: US 2016/0053970 A1
(43) Pub. Date: Feb. 25, 2016

(54) Illuminating Decoration Device

(71) Applicant: Hua-Cheng Pan, Tainan City (TW)

(72) Inventor: Chih-Liang Wang, Tainan (TW)

(21) Appl. No.: 14/462,571

(22) Filed: Aug. 19, 2014

(51) Int. Cl. F21V 11/16; F21V 15/01; F21V 23/00; F21S 9/02

(52) U.S. Cl. CPC F21V 11/16; F21S 9/02; F21V 15/01; F21V 23/007; F21W 2121/006

(57) ABSTRACT

The illuminating decoration device contains a casing member, a bottom cover, and a projection sheet. The casing member is a hollow, three-dimensional, translucent object having a bottom opening. The bottom cover seals the bottom opening. A control circuit and a white-light light emitting diode (LED) inside the casing member are on the bottom cover. The LED is electrically connected to the control circuit. The projection sheet inside the casing member has a bottom edge fixedly joined to the bottom cover and surrounds the LED. The projection sheet has a pattern on a surface. When the control circuit is powered up, the light produced by the LED projects the pattern of the projection sheet onto the casing member, and the white light of the LED enhances the color saturation of the projected pattern on the casing member, thereby producing a variety of visual effects.

### TECHNICAL FIELD OF THE INVENTION

The present invention is generally related to decoration devices, and more particular to an illuminating decoration device providing vivid visual effects.

### DESCRIPTION OF THE PRIOR ART

In recent years, as people are more concerned about the quality of their lives, the demands for lamps and decoration devices that are visually appealing or capable of creating a soothing atmosphere are increasing.

In addition, when people decorate their homes, they often need lamps and decoration devices of different shapes and functions to match the other furniture. These types of lamps and decoration devices are therefore more competitive in the market. The present inventor therefore teaches an illuminating decoration device that, besides functioning as a decoration, are also practical, handsome, and interesting.

### SUMMARY OF THE INVENTION

A major objective of the present invention is to enhance the visual effect of a decoration device and therefore the decoration device's market competitiveness. The present invention as such teaches an illuminating decoration device containing the following components.

There is a hollow, three-dimensional, translucent casing member having a bottom opening on a bottom side of the casing member.

There is a bottom cover sealing the bottom opening, a control circuit inside the casing member on an inner side of the bottom cover, a white-light light emitting diode (LED) inside the casing member on the inner side of the bottom cover electrically connected to the control circuit.

There is a projection sheet inside the casing member having a bottom edge fixedly joined to the inner side of the bottom cover and surrounding the LED. The projection sheet has a pattern on a surface of the projection sheet.

When the control circuit is powered up, the light produced by the LED projects the pattern of the projection sheet onto the casing member, the white light of the LED enhances the color saturation of the projected pattern on the casing member. In addition, a portion of the light from LED is diffused around, producing a variety of visual effects.

In an embodiment of the present invention, the projection sheet is rolled into a cone-like shape converging away from the bottom cover so that the projected pattern on the casing member has vivid perspective.

In an embodiment of the present invention, the bottom cover is configured with a switch on an outer side of the bottom cover electrically connected to the control circuit for powering the control circuit up and off.

In an embodiment of the present invention, the pattern contains at least one of a graphic image, a text, and a symbol.

In an embodiment of the present invention, the bottom cover is configured with an inward indentation towards the control circuit and the LED, and the inward indentation houses a battery.

In an embodiment of the present invention, the illumination decoration device further contains comprising a battery cover sealing the inward indentation. The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become apparent to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an illuminating decoration device according to an embodiment of the present invention.

FIG. 2 is a perspective break-down diagram showing the various components of the illuminating decoration device of FIG. 1.

FIG. 3 is a sectional diagram showing the illuminating decoration device of FIG. 1.

FIG. 4 is a perspective diagram showing the illuminating decoration device of FIG. 1 from an upward view angle.

FIG. 5 is a side-view diagram showing a pattern projected on a casing member of the illuminating decoration device of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

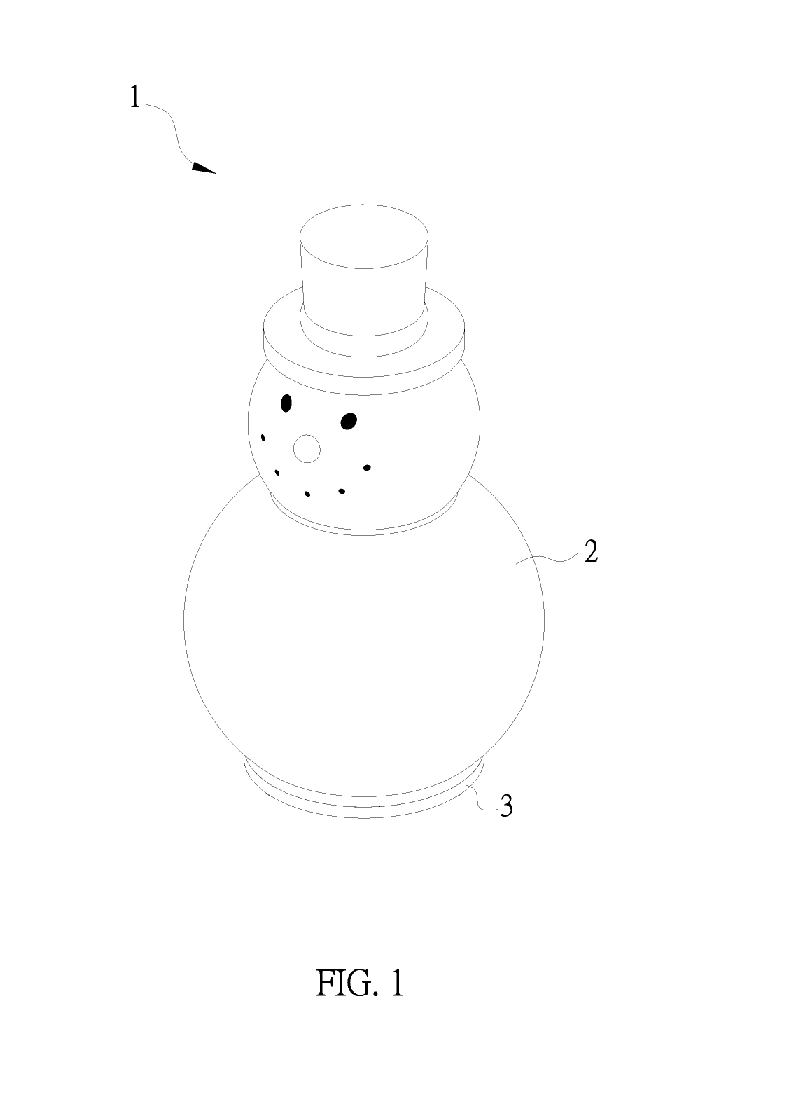

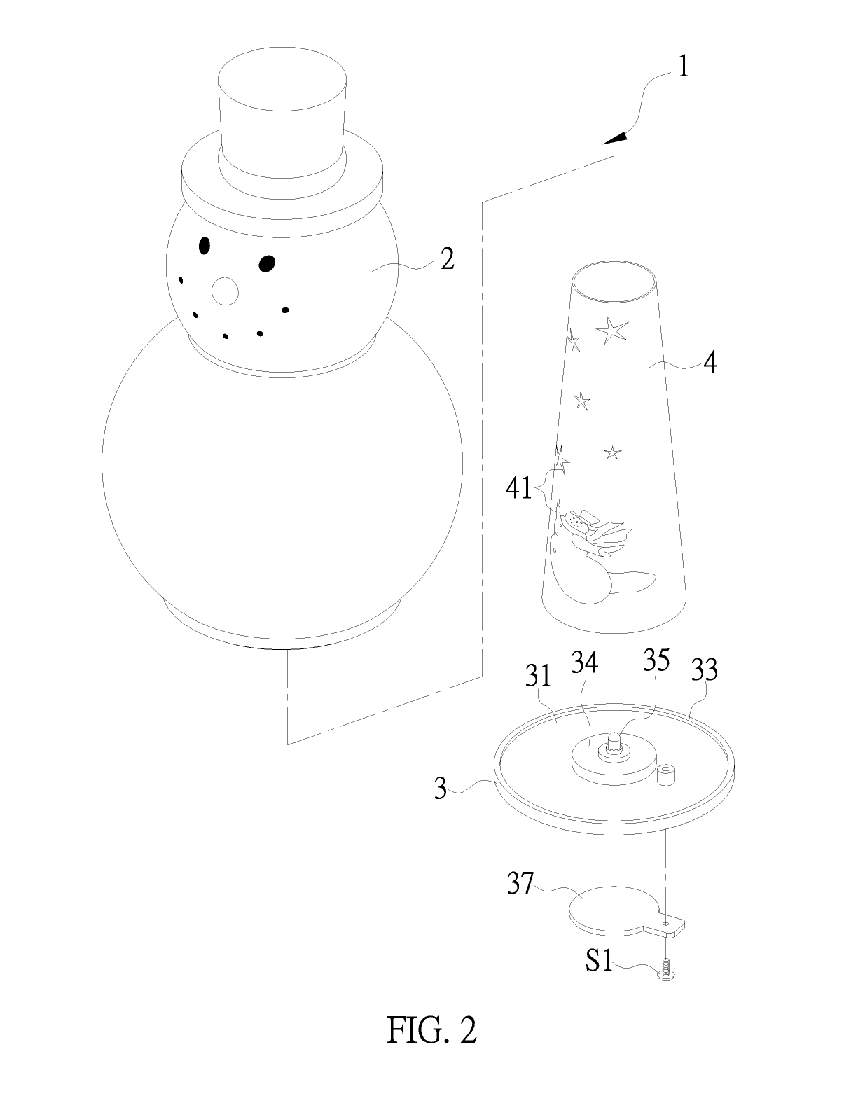

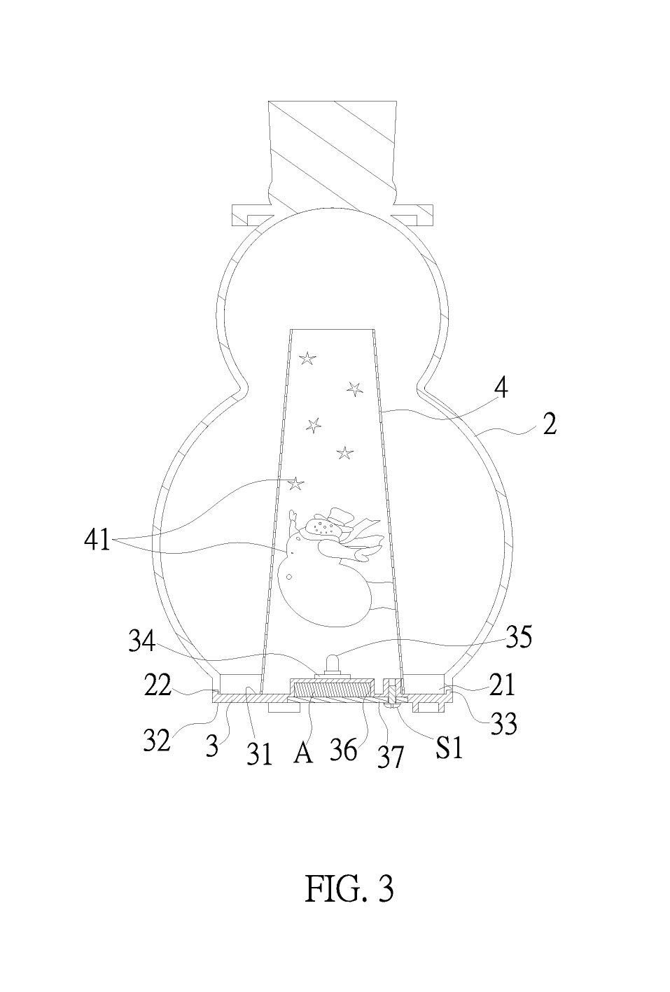

FIG. 1 is a perspective diagram showing an illuminating decoration device 1 according to an embodiment of the present invention. FIG. 2 is a perspective break-down diagram showing the various components of the illuminating decoration device 1. FIG. 3 is a sectional diagram showing the illuminating decoration device 1.

As illustrated in FIGS. 1 to 3, the illuminating decoration device 1 contains a casing member 2, a bottom cover 3, and a projection sheet 4. The bottom cover 3 is joined to a bottom side of the casing member 2. The projection sheet 4 is housed inside the casing member 2 and has a bottom edge fixed to the bottom cover 3.

The casing member 2 is of a hollow three-dimensional shape and has a bottom opening 21 on the bottom side. The bottom opening 21 is surrounded by a casing flange 22. In the present embodiment, the casing member 2 is shaped like a snowman with matted and translucent walls. However this is only exemplary and is not intended to limit the present invention.

The bottom cover 3 seals the bottom opening 21 of the casing member 2. The bottom cover 3 has an inner side 31 and an outer side 32. A cover flange 33 is configured on the inner side 31 of the bottom cover 3. In one embodiment, the cover flange 33 surrounds the casing flange 22. Alternatively, the casing flange 22 surrounds the cover flange 33. The bottom cover 3 also has a control circuit 34 and at least a white-light light emitting diode (LED) 35 on the inner side. The LED 35 is electrically connected to the control circuit 34 and the control circuit 34 controls the illumination of the LED 35 such as its flash frequency.

The projection sheet 4 is rolled into a cone-like shape converging upward (i.e., away from the control circuit 34 and the LED 35) and surrounding the LED 35. The projection sheet 4 has a bottom edge fixedly joined to the inner side of the bottom cover 3 by adhesion, locking, or other fastening means. The projection sheet 4 has a colored pattern 41 on its surface. The colored pattern 41 can contain graphic images, texts, and symbols. In the present embodiment, the projection sheet 4 is an ordinary flexible transparent plastic film, and the colored pattern 41 is spray-coated or other means on the projection sheet 4.

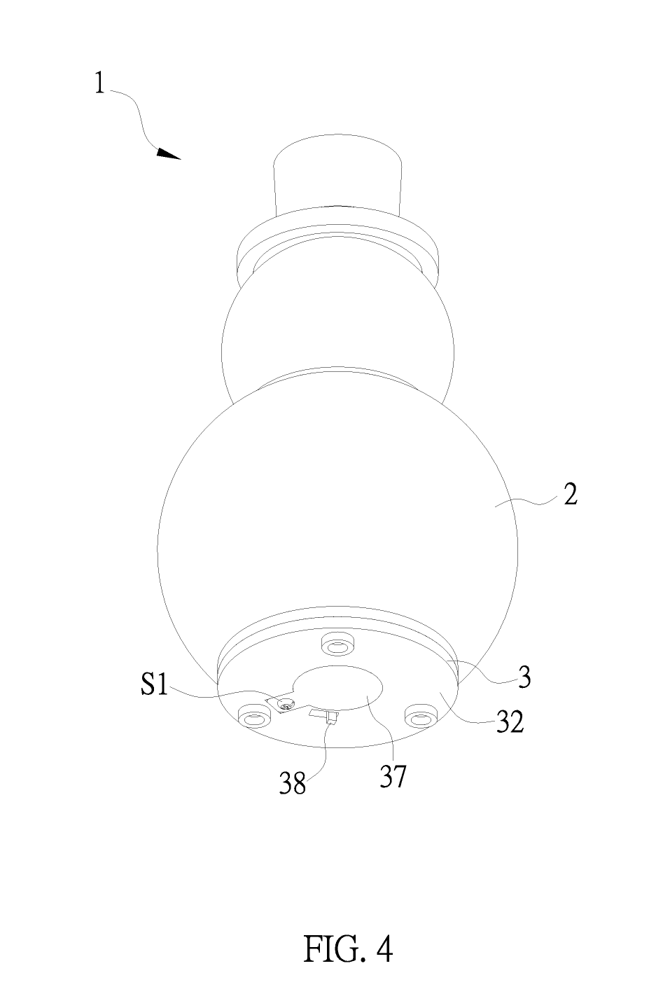

As further shown in FIG. 4, which is a perspective diagram showing the illuminating decoration device 1 from an upward view angle, the outer side 32 of the bottom cover 3 has an inward indentation 36 (i.e., inwardly indented towards the LED 35) for housing a battery A, which provides the electricity required by the present invention. The indentation 36 is sealed by a battery cover 37 fastened to the outer side 32 by a bolt S1. The bottom cover 3 is also configured with a switch 38 electrically connected to the control circuit 34. In the present embodiment, the switch 38 is located on the outer side 32 of the bottom cover 3, but this is only exemplary. The switch 38 turns on and off the control circuit 34 (and therefore, the LED 35) by closing and opening the connection to a power source. The power source can be the battery A, an external AC source, or an external DC source. There can a variety of power sources and they are not part of the claimed invention, thereby omitting their details.

The casing member 2 and the bottom cover 3 can be made of a translucent material such as plastic, paper, or glass. Again, these are only exemplary, and are not intended to limit the present invention.

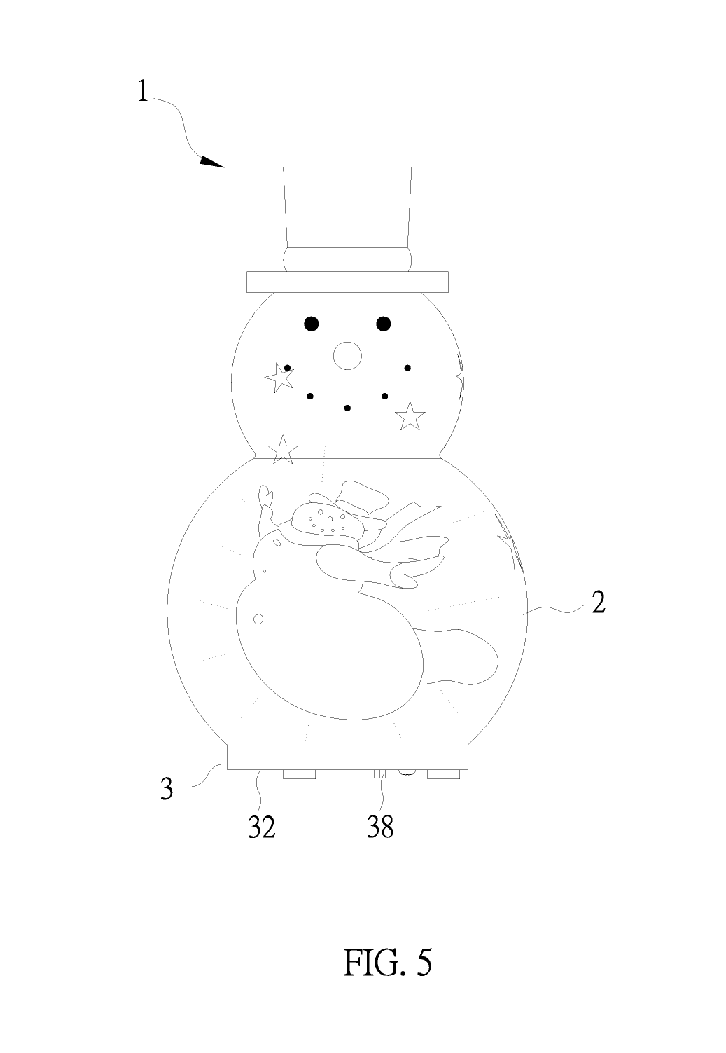

As shown in FIG. 5, when the switch 38 is turned on and the control circuit 34 is powered up, the white light produced by the LED 35 projects on the pattern 41 of the projection sheet 4 onto the casing member 2. As the projection sheet 4 is rolled into a cone shape, the projected pattern 41 on the casing member 2 has vivid perspective. Through the white light of the LED 35, the color saturation of the projected pattern 41 on the casing member 2 is enhanced. In addition, a portion of the light from LED 35 is diffused around, producing a variety of visual effects.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A illuminating decoration device, comprising:
a hollow, three-dimensional, translucent casing member having a bottom opening on a bottom side of the casing member;
a bottom cover sealing the bottom opening;
a control circuit inside the casing member on an inner side of the bottom cover;
an light emitting diode (LED) inside the casing member on the inner side of the bottom cover electrically connected to the control circuit; and
a projection sheet inside the casing member has a bottom edge fixedly joined to the inner side of the bottom cover and surrounds the LED, the projection sheet having a pattern on a surface of the projection sheet.

2. The illuminating decoration device according to claim 1, wherein the projection sheet is rolled into a cone-like shape converging away from the bottom cover.

3. The illuminating decoration device according to claim 1, wherein the bottom cover is configured with a switch on an outer side of the bottom cover electrically connected to the control circuit.

4. The illuminating decoration device according to claim 1, wherein the pattern contains at least one of a graphic image, a text, and a symbol.

5. The illuminating decoration device according to claim 1, wherein the bottom cover is configured with an inward indentation towards the control circuit and the LED; and the inward indentation houses a battery.

6. The illuminating decoration device according to claim 5, further comprising a battery cover sealing the inward indentation.
